(19) United States
(12) Patent Application Publication
(10) Pub. No.: US 2002/0055176 A1
(43) Pub. Date: May 9, 2002

(54) Diagnostic assay system

(76) Inventor: Robert A. Ray, Stuart, FL (US)

Correspondence Address: Stanley A. Kim, Akerman, Senterfitt & Eidson, P.A., Suite 400, 222 Lakeview Avenue, West Palm Beach, FL, 33402-3188, US

(21) Appl. No.: 09/929,751

(22) Filed: Aug. 14, 2001

Related U.S. Application Data
(60) Provisional application No. 60/246,775, filed on Nov. 8, 2000.

(51) Int. Cl. G01N 31/00

(52) U.S. Cl. 436/67; 436/518; 435/8; 435/29

(57) ABSTRACT

Disclosed is a method for performing an analytical assay by providing a kit for collecting and storing a test sample, the kit including a sample collection device, a sample storage device, and a printed material having indicated thereon an electronic address for accessing the result of the assay; using the kit to collect a specimen from a test subject at a first location such as the subject's home or a health care provider's office; transporting the collected specimen to an off-site laboratory; analyzing the specimen at the off-site laboratory; and reporting the result of the analysis over a computer communications network such as the Internet.

### CROSS REFERENCE

The present application claims the benefit of U.S. provisional application serial No. 60/246,775 filed Nov. 8, 2000.

### FIELD OF THE INVENTION

The invention relates to the field of diagnostic assays. More particularly, the invention relates to a method for collecting specimens at a first site, transporting the specimen to a second site, analyzing the specimen at the second site, and reporting results of the analysis using a computer communications network.

### BACKGROUND

Conventional clinical testing involves several steps. In general, a patient or test subject first visits a hospital or health care provider's office where a biological sample such as blood, urine, saliva, sputum, feces, cerebrospinal fluid, hair, skin, or other tissue is isolated from the patient. The sample is then packed and shipped to a clinical laboratory where it is analyzed using conventional instrument-based “wet chemistry” analysis. The results of the analysis are then compiled and a written report is sent back to the health care provider, who then relays the results to the patient.

Utilizing off-site laboratories for clinical chemistry analyses is advantageous in that such laboratories are typically equipped to perform a wide variety of assays, complicated as well as simple. In addition, the results obtained from such laboratories are generally very accurate. From the perspective of a patient, the use of off-site clinical laboratories is often viewed as inconvenient in that a test subject must typically (a) go through a health care provider to submit a specimen for analysis, (b) await the return of written results from the off-site laboratory to the health care provider, and (c) wait for the health care provider to disclose the results.

To avoid the delays encountered using off-site laboratories, many different devices have been developed for on-site testing of biological samples. These devices can be broadly classified into two groups: those for in home use by laymen, and those for use by a skilled health care provider. Devices that are particularly reliable, easy to use, and not for diagnosing serious diseases have been approved for use at home by consumers at large. Common examples of such “at home” devices include at home pregnancy tests for determining the presence of human chorionic gonadotropin in urine, and at home ovulation tests for determining the presence of luteinizing hormone in urine. At home devices are also available for detecting illegal drug use, viral infections, and blood cholesterol and glucose levels.

Other on-site testing devices are slightly more complicated and have only been approved for use by medical professionals. Such “point-of-care” tests can be performed at a health care provider's office by trained personal to provide a rapid diagnostic result. Examples of such devices include those for diagnosing infections caused by particular microorganisms. For instance, devices for rapid on-site testing are currently available for diagnosing infections caused by: group A streptococci; influenza viruses; Helicobacter pylori; Epstein-Barr virus; Human immunodeficiency virus (HIV)-1; and HIV-2. Other currently available point-of-care devices for rapidly analyzing chemical components in biological specimens include urine dip sticks for analyzing urine for specific gravity, pH, leukocytes, nitrites, total protein, albumin, glucose, ketone bodies, urobilinogen, bilirubin, erythrocytes, and hemoglobin; and blood dip sticks for analyzing blood components such as glucose.

The vast majority of at home or point-of-care devices are either enzyme-based immunoassays or simple chemical reactant assays that quickly provide a readout that is easily discernable to the naked eye. The results are most typically indicated either as a positive or negative result; e.g., pregnant or not pregnant; or infected or not infected. Some of the chemical reactant assays are semi-quantitative in that they can provide a range of values rather than only a positive or negative result.

While all of the foregoing at home or point-of-care devices are advantageous in their rapidity and convenience, conventional off-site clinical testing is still the predominant method used for performing most diagnostic assays for at least a couple of reasons. First, many clinical assays mandate the use of complicated protocols which often require the use of expensive instruments not commonly available in most health care provider's offices. Second, many assays demand a high degree of accuracy that can only be provided by conventional clinical chemistry analysis.

### SUMMARY

What has been developed is a method for performing a biological assay by collecting a specimen from a test subject at a first location such as the subject's home or a health care provider's office; transporting the collected specimen to an off-site laboratory; analyzing the specimen at the off-site laboratory; and reporting the results of the analysis over a computer communications network such as the Internet so that the subject or his health care provider can access the results without having to wait for a courier or postal service to deliver written results.

Accordingly the invention features a method for performing an analytical assay on a test sample. The method includes the steps of: (A) providing a kit for collecting and storing a test sample, the kit including a sample collection device, a sample storage device, and a printed material having indicated thereon an electronic address for accessing a test result obtained from analysis of the sample; (B) collecting the test sample from a subject at a first location using the sample collection device; (C) placing the collected sample into the sample storage device; (D) transporting the sample storage device containing the collected test sample to an off-site laboratory; (E) analyzing the collected test sample for at least one analyte at the off-site laboratory to generate the test result; and (F) posting the test result over a computer communications network.

In the foregoing method, the first location can be, e.g., a private residence; a health care provider's office; or a hospital. The step of transporting the sample storage device containing the collected test sample to an off-site laboratory can be performed by mailing the sample storage device to the off-site laboratory.

Analytes that can be assayed in the method include blood, hemoglobin (e.g., a glycolsylated hemoglobin such as hemoglobin A1c), lipids, total cholesterol, HDL cholesterol, LDL cholesterol, triglycerides, homocysteine, CR protein, ALT, calcium, phosphate, acid phosphatase, prostate specific antigen, and microalbumin. The analyte can also be a microorganism such as a bacterium, e.g., staphylococci, streptococci, neisseria, enterobacteria, vibrionacae, pseudomonas, brucella, yersinia, francisella, , haemophilus, bortadella, legionella, bacillus, clostridium, corynbacteria, listeria, mycobacteria, treponema, borrelia, leptospira, mycoplasma, rickettsiae, or chlamydiae. The microorganism may also be a fungus or a virus such as herpes simplex virus (HSV)-1, HSV-2, varicella-zoster, cytomegalovirus, EBV, polyomavirus, papillomavirus, adenoviridae, parvovirus, adeno-associated virus, poxviridae, HIV-1, HIV-2, non-HIV retroviridae, Hepatitis A virus (HAV), Hepatitis B virus (HBV), Hepatitis C virus (HCV), togaviridae, bunyaviridae, polioviruses, coxsackieviruses, echoviruses, rhinoviruses, reoviruses, rotaviruses, orbiviruses, coraonaviridae, influenza A, influenza B, influenza C, paramyxoviridae, rhabodoviridae, or arenaviridae. The analyte might also be a prion such as one associated with bovine spongiform encephalopathy or Creutzfeld-Jacob syndrome, or a protozoum such as a helminth.

The computer communications network of the invention can be a global communications network such as the Internet, a local area network, or a wide area network. The kit used in the method can further include at least one component (e.g., the sample storage device) marked with a unique code for identifying the kit. The unique code for identifying the kit can include a sequence of at least 3 alphanumeric characters or a barcode.

The method of the invention can also include a step of providing a Web page that is adapted to allow a person to enter the unique code onto the Web page and transmit an electronic message containing the unique code from a first computer communication network access device remotely-located from the off-site laboratory over the computer communications network to a second computer communication network access device located at the off-site laboratory. The computer located at the off-site laboratory can receive the electronic message containing the unique code and respond by transmitting an electronic message containing the test results over the computer communications network to the first computer communication network access device.

The sample collection device used in the method of the invention can include a blotter material adapted to receive a blood sample. It can also include a separation member and a collection member where the separation member features a filter that receives a blood sample and selectively retains cellular components contained within the blood sample while allowing non-cellular components to pass through; and where the collection member includes a blotter material that receives the non-cellular components of the blood sample after the non-cellular components have passed through the separation member. In other versions of the invention, the sample collection device can have a relatively rigid strip forming a handle member having a handle end and a collection end, the collection end having a collection pad for collecting and drying a urine sample.

In the method of the invention, the kit can additionally include packaging for mailing the sample storage device. The packaging for mailing can be marked with a mailing address of the off-site laboratory.

In another aspect, the invention features a method for performing an analytical assay on a test sample. This method includes the steps of: (A) collecting the test sample from a subject at a first location; (B) transporting the collected test sample to an off-site laboratory; (C) analyzing the collected test sample for at least one analyte at the off-site laboratory to generate test results; and (D) electronically transmitting the test results over a computer communications network to an electronic post office box. The electronic post office box can be, e.g., the subject's electronic post office box or the subject's health care provider's mailbox.

Also within the invention is a kit for performing an analytical assay on a test sample. The kit can include a printed material having indicated thereon an electronic address for accessing a test result obtained using the kit, written instructions for using the kit; a printed material having indicated thereon an alphanumeric code for uniquely identifying the kit; a means for isolating a sample; a sample storage device for storing the sample; and a container adapted to contain the sample storage device in a manner such that the sample storage device can be transported to an offsite laboratory. The sample can be a biological sample and the kit can further feature a sample collection device such as a lancet, needle, syringe, razor, or scissors.

The written instructions for using the kit and the printed material having indicated thereon an electronic address for accessing a test result obtained using the kit can both be on a single sheet of paper. The kit can also include an envelope having indicated thereon a mailing address of the offsite laboratory. The printed material having indicated thereon the alphanumeric code for uniquely identifying the kit can be a test request form adapted such that a test subject is prompted to enter information thereon including one or more of the test subject's name, the test subject's mailing address, the test subject's electronic mail address, the test subject's age, the test subject's sex, the test subject's telephone number; a date the sample was applied to the sample storage device, the test subject's medical condition, the test subject's medical history, or the test subject's medical care provider. The sample storage device can be a blotter material, test tube for storing liquid, plastic container, or envelope. The test sample can be blood, and the biological assay is can be assay for an analyte such as hemoglobin A1c, lipids, total cholesterol, HDL cholesterol, LDL cholesterol, triglycerides, homocysteine, CR protein, ALT, calcium, phosphate, acid phosphatase, or prostate specific antigen. The test sample can also be urine and the biological assay is an assay for an analyte such as microalbumin or calcium. The analyte can also be one of the foregoing microorganisms or prions.

As used herein, the phrase “off-site laboratory” means any room or building outfitted to analyze a test sample (e.g., a biological or chemical sample) that is remotely located (e.g., at least 0.2, 0.5, 1, 2, 5, 10 or more kilometers away) from the site at which the test sample was collected.

By the word “mailing” is meant to send via a postal system such as the United States Postal Service, its foreign counterparts, or a courier service such as the overnight courier service provided by Federal Express or United Parcel Service.

As used herein, the phrase “computer communications network” means a group of two or more computer systems communicatively linked together. For example, a “local area network” or “LAN” is computer communications network where the linked computers are geographically close together (e.g., in the same building). A “wide area network” or “WAN” is another computer communications network similar to a LAN except that the linked computers are farther apart (e.g., they are in different buildings and connected by telephone lines or radio waves). A “global” computer communications network is one that is not limited to a certain geographical area or number of individual computers, but rather links computers throughout the world generally without restriction. The Internet is an example of a global computer communications network.

Something (e.g., test results) is “posted” over a computer communications network when it is made available in a computing device connected to the network that is accessible to other computing devices connected to the network. For example, tests results are “posted” when the results are added to a database in a server that can be remotely accessed by a computing device via a computer communications network such as the Internet.

By the phrase “electronic address” is meant a name or token that identifies a network component. For example, on the Internet, every file has a unique address called a URL or uniform resource locator which is an alphanumeric sequence that can be used to direct the browser of one computer communications network access device linked to the Internet to a Web page published by a server linked to the Internet.

When used as a verb herein, the phrases “electronic mail” or “e-mail” means to transmit one or more messages over a computer communications network. When used as a noun, these phrases mean a message transmitted over a computer communications network. The messages can be, e.g., notes entered from a keyboard or electronic files stored on disk. By the phrase “electronic post office box” or “electronic mailbox” is meant an area in memory or on a storage device where e-mail is placed. An “electronic mailbox address” or “e-mail address” is a name that identifies an electronic post office box on a network where e-mail can be sent. For example, on the Internet, all e-mail addresses presently have the form: <name>@<domain name>.

As used herein, the term “server” means a computer or device on a network that manages network resources, e.g., processes data coming in from a computer communications network, stores files in a database, and outputs files from a database over the computer communications network.

By the term “Web browser,” or simply “browser,” is meant a software application that enables one to access and use the facilities of a Web site, i.e., to locate and display Web pages. Presently, two of the most popular browsers are Netscape Navigator® and Microsoft Internet Explorer®.

“Computer program” means a writing that sets forth instructions that can direct the operation of an automatic system capable of storing, processing, retrieving, or transferring information. When a computer program is entered into a computer system, it forms part of the system referred to as “software.” By the term “hardware” is meant physical components of a computer system.

As used herein, a “Web site” is a site (location) on a computer communications network such as the Internet containing one or more Web pages. Most Web sites contain a “home page”, which is the main page of a Web site and usually first screen users see when they enter the site. Home pages often offer an introduction to the material contained in the Web site and also an index or table of contents hyperlinked to related Web page documents of the site. By the phrase “Web page” is meant a document published on a computer communications network.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions will control. In addition, the particular embodiments discussed below are illustrative only and not intended to be limiting.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 is a schematic view of a kit for performing an analytical assay according to a method of the invention.

FIG. 2 is a schematic view of a Test Request Form for use in conjunction with performing an analytical assay.

FIG. 3 is a flow diagram outlining various steps of a method for performing an analytical assay.

FIG. 4 is a pictorial representation of a computer communications device and off-site laboratory server connected to a computer communications network.

FIG. 5 is a series of screen shots illustrating various hypermedia documents (e.g., Web pages) used in a method for reporting a test result over a computer communications network.

### DETAILED DESCRIPTION

Described herein is a system including methods and kits for performing an analytical assay on a test specimen. A method of the invention includes the steps of: collecting a specimen from a test subject at a first location; transporting the collected specimen to an off-site laboratory; analyzing the specimen at the off-site laboratory; and reporting the results of the analysis over a computer communications network such as the Internet so that the subject or his health care provider can access the results without having to wait for a courier or postal service to deliver written results. To facilitate performance of the method, the invention also features a kit including a means for isolating a biological sample from a test subject; a sample storage device for storing the biological sample; and a sample container adapted to contain the sample storage device in a manner such that the sample storage device can be transported to an offsite laboratory. The kit also includes various printed materials including written instructions for using the kit, material marked with an alphanumeric code for uniquely identifying the kit, and material marked with an electronic address for accessing a test result obtained using the kit. The below described preferred embodiments illustrate various adaptations of the invention. Nonetheless, from the description of these embodiments, other aspects of the invention can be readily fashioned by making slight adjustments or modifications to the components and steps discussed below.

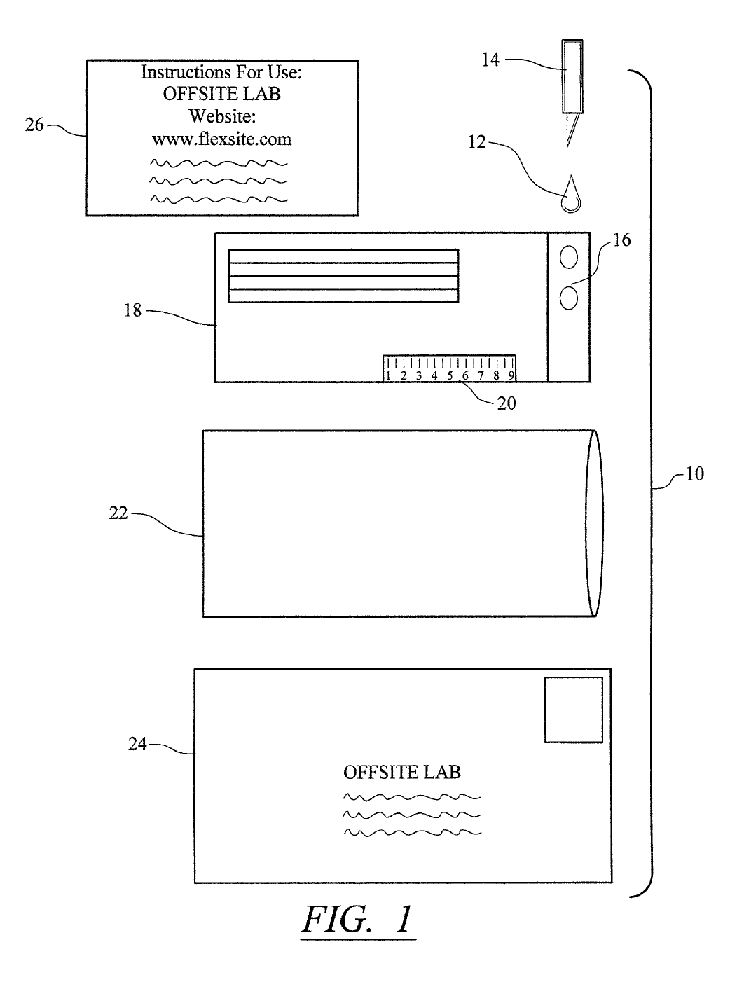

Referring to FIG. 1 of the drawings, a presently preferred embodiment of sample analysis kit 10 includes a sample collection device 14 for collecting a sample 12, a sample storage device 16 for storing the sample obtained using collection device 14, a test report form 18 having thereon an identifying code 20 and being attached to storage device 16, a container 22, a transport device 24, and instructions for using the kit 26. For convenient storage and shipping, each of the components of kit 10 can be packaged within a cardboard container (not shown).

Collection device 14 is used to collect sample 12 from a test subject from the subject's home, his health care provider's office, or a hospital. For at home or point-of-care sample collection, collection device 14 can be any apparatus that can be used to isolate a biological specimen from a test subject. For example, for taking a blood sample, collection device 14 is preferably a sterile lancet as shown in FIG. 1. In other embodiments, device 14 can be a syringe for taking blood samples; a sharp-edged instrument such as a razor for taking skin scrapings; a cotton swab for taking saliva, sputum, feces, semen, buccal, pharyngeal, nasal, or vaginal samples; or even scissors for taking hair samples.

In the preferred embodiment described, sample 12 is generally a biological sample (e.g., a drop of peripheral blood as shown in FIG. 1) isolated from a living human test subject. Nonetheless, in other embodiments of the invention, sample 12 can be any biological (see examples above), chemical, or other material having at least one analyte that can be measured. For example, sample 12 can be a tissue specimen taken from any species of organism (living or dead) from which a sample can be collected, e.g., a dog, cat, rodent, fish, horse, cow, sheep, goat, etc. Sample 12 can also be a non-biological material. For example, in various embodiments of the invention sample 12 can take the form of a sample of air, water, food, beverage, etc., e.g., to test sample 12 for pollutants or adulterants.

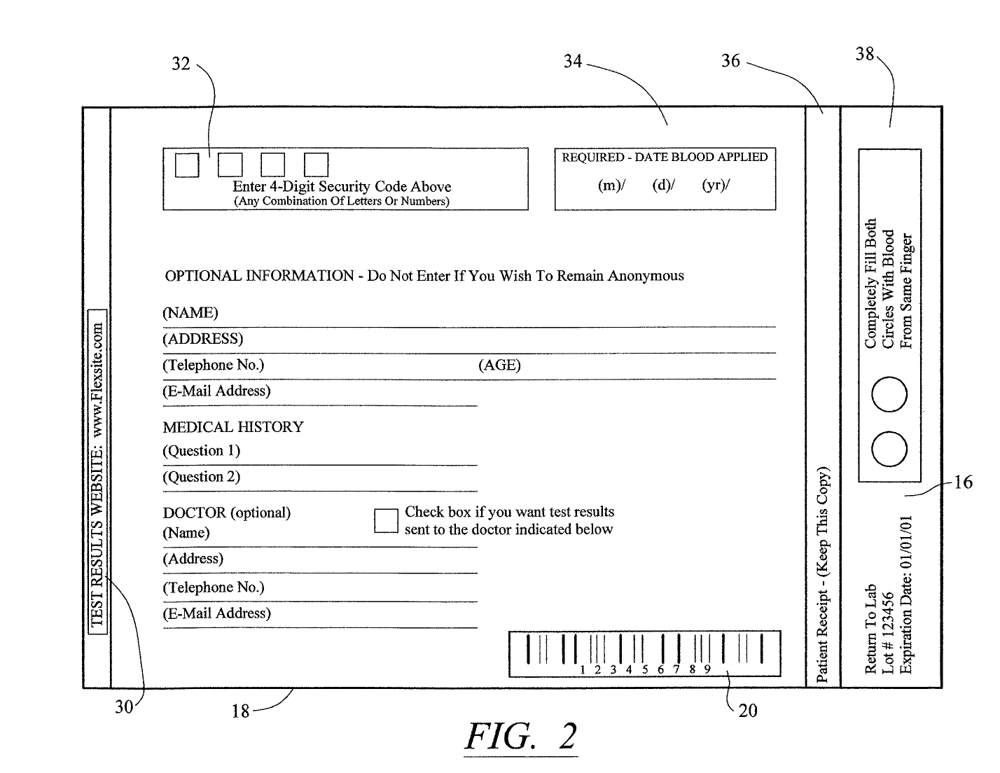

After isolation using collection device 14, sample 12 can be directly placed into transport device 24 for shipping to an off-site laboratory. Preferably, however, isolated sample 12 is first transferred (e.g., wiped, blotted, pipetted, etc.) to sample storage device 16. Sample storage device 16 can be a passive device that merely holds and/or stabilizes (e.g., using a preservative or chilled compartment) sample 16 until it is analyzed. In the preferred embodiments shown in FIGS. 1 and 2, storage device 16 is a blotter material adapted for absorbing or adsorbing liquid samples. In other embodiments, device 16 can take the form of a paper envelope; a test tube for storing liquids such as blood or urine (e.g., an evacuated, sterile test tube containing an anticoagulant); or a clean sterile plastic container for holding samples such as skin scrapings, hair clippings, or swabs. Numerous suitable storage devices that can be adapted for use in the invention are known.

In other preferred embodiments (not shown in the drawings), especially for blood samples, storage device 16 is active in that it performs one or more purification and/or reaction steps prior to analysis. For example, for assays on blood where it is advantageous to separate blood cells from non-cellular blood components such as serum or plasma, storage device 16 can include a separation member (e.g., a filter) for dividing cells from other components, and a collection member for absorbing and storing the other components. As another example, storage device 16 can have a reactant impregnated in a blotter material that absorbs sample 12. Application of sample 12 to the blotter material causes the sample to react with the reactant. In a particular application of the foregoing device, the blotter material is impregnated with an antibody that specifically binds a predetermined antigen. In another application, the blotter material is impregnated with an enzyme that specifically binds an analyte to be assessed. Exemplary blotting materials suitable for this application are described in U.S. Pat. Nos. 5,496,626; 5,460,057; 5,415,758; 4,790,797; and 4,774,192.

For storing a urine sample, sample storage device 16 preferably takes the form of a sample collection strip or “dipstick” comprising the handle member and collection pad. See, e.g., International Application No. WO1999US0031129 published Jul. 6, 2000. This device is used by applying a urine sample to the collection pad, e.g., by holding the strip at the handle end and contacting the collection pad with a liquid urine sample to saturate the collection pad. In particularly preferred variations of this embodiment, the pad is adapted to be dried, packaged for shipping, and then transported to a laboratory for analysis. To facilitate analysis at an off-site laboratory, the collection pad is made of a material suitable for performing an extraction to recover an analyte of interest from the collection pad.

For storing a blood sample, storage device 16 preferably takes the form of a device having a separation member that separates certain undesirable components (e.g., red blood cells) from the components of interest (e.g., plasma or serum containing an analyte) in the sample; and a collection member for collecting (e.g., by absorption) and storing the component of interest in the sample for subsequent transport to and analysis in an off-site laboratory. See, e.g., International Patent Application No. WO1999US0023680 published Apr. 20, 2000. More preferred versions of the foregoing device also include a wicking bridge fluidly interposed between the separation member and the collection member. The wicking bridge being made up of a strip of porous material that transports serum or plasma from the separation member to the collection member.

Referring now to FIG. 2, sample storage device 16 and test report form 18 are shown in more detail. In this embodiment, form 18 is made up of three sheets of paper (top sheet 34 and bottom sheet 38 marked “Return To Lab;” middle sheet 36 marked “Patient Receipt-(Keep this copy)”) each printed with identical information, and adapted so that any writing on top sheet 34 also appears on middle sheet 36 and bottom sheet 38 (e.g., similar to method of making copies using carbon paper). Device 16 is attached to bottom sheet 38 for identification purposes. Form 18 has printed thereon blank spaces for indicating (e.g., by writing or typing) a test subject's name, age, mailing address, and telephone number; date sample applied; various medical questions (can be varied according to the particular test to be performed); a health care provider's name and signature (if necessary to authorize the test); an identifying code 20; the electronic address of the offsite laboratory 30; and a security code 32 (the test subject can enter a self-chosen alphanumeric personal identification code for additional security and identification purposes). Form 18 also indicates that if the test subject desires anonymity, with the exception of the date sample applied, the other requested information should be left blank.

In order to facilitate identification of the particular kit 10 associated with a particular sample 12, storage device 16 and form 18 are marked with identifying code 20, which can be any symbol or series of symbols that identifies the particular kit 10. For example, as shown in FIG. 2, identifying code 20 can take the form of a series of alphanumeric characters (e.g., a string of 3, 4, 5, 6, 7, 8, 9 or more letters and numbers) that can be used as a unique code or serial number for identifying a particular sample collection kit. In a particularly preferred embodiment, identifying code 20 is present in both the alphanumeric sequence and a barcode corresponding to the alphanumeric sequence. Code 20 can also be stamped or otherwise secured on kit 10's packaging, collection device 14, test report form 18, container 22, transport device 24, instructions for using the kit 26, or any other component of kit 10. Preferably, code 20 is marked on a component of kit 10 that the test subject (and/or his health care provider) can retain for later identifying the test results obtained from the particular sample 12 isolated using the particular kit 10.

Referring again to the embodiment shown in FIG. 1, kit 10 includes a container 22 into which sample storage device 16 is placed prior to sealing in transport device 24. While not mandatory for all types of samples, container 22 is a device that protects the sample 12 collected on storage device 16 from being exposed to the environment during shipping. It can therefore take the form of any device which can contain device 16. For example, a presently preferred form of container 22 is a waterproof or otherwise impervious bag (e.g., a sealable plastic bag) sized to contain device 16 and to fit inside transport device 24.

Whether or not kit 10 includes a container 22, device 16 containing collected sample 12 can be placed into transport device 24 for shipping to an off-site laboratory (i.e., the site where sample 12 is to be analyzed). Transport device 24 can be any type of packaging that can contain the sample 12 collected on device 16 in a manner suitable for transport (e.g., by mail or courier service). For larger or fragile items, the transport device preferably is a rigid or semi-rigid plastic or cardboard box. As shown in FIG. 1, for smaller and/or less fragile items, transport device 24 preferably takes the form of an envelope. To further protect or isolate the collected sample 12, especially where kit 10 does not include a container 22, transport device 24 can be made of, or lined with, a waterproof or impervious material. For the test subject's or health provider's convenience, preferred versions of transport device 24 are marked with the mailing address of the off-site laboratory. In some cases, postage for the transport device is prepaid.

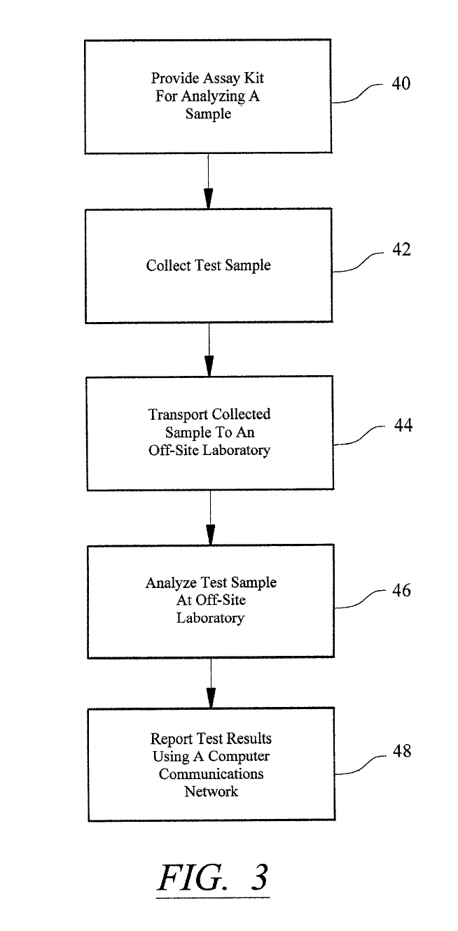

An overview view of a preferred method for using the kits within the invention for performing an assay on a test specimen is shown in FIG. 3. This method includes a step 40 of providing an assay kit, a step 42 of collecting a test sample, a step 44 of transporting the collected test sample to an off-site laboratory, a step 46 of analyzing the test sample at the off-site laboratory; and a step 48 of using a computer communications network to report the test results.

Step 40 of providing an assay kit is preferably performed by a test subject or health care professional purchasing or otherwise obtaining a kit for analyzing a sample such as kit 10 described herein. Alternatively, step 40 can be performed by individually purchasing and assembling together the various components that make up a kit for analyzing a sample suitable for use with the present invention (e.g., a sample collection device, a sample storage device, a transport device, etc.).

Step 42 of collecting a test sample can be performed by any method known for taking a sample. For example, a preferred method for collecting a blood sample from a human test subject involves using a sterile lancet (e.g., forming part of the kit provided in step 40) to prick a finger; squeezing the pricked finger to produce a drop of blood from the prick site; and placing the produced blood drop onto a blotter material (e.g., that forming part of the sample storage device of the kit of step 40). Many other methods for performing this step are known in the art, and can be readily adapted for use in the present invention. For example, scissors can be used to collect a hair sample, and swabs can be used to take a mucosal sample.

For step 44 of transporting the collected test sample to an off-site laboratory, the exact method of transporting the sample from the location where the sample is collected to an off-site laboratory is not critical as long as delivery to the off-site laboratory occurs within a reasonable time (e.g., 1-4 days). In most cases, the preferred method for performing step 44 is by mailing the sample collected in step 42 to an off-site laboratory. This can be accomplished by placing the collected sample into an envelope marked with the mailing address of the off-site laboratory, placing correct postage on the envelope, and depositing the envelope with a postal service such as the United State Postal Service so that the envelope is delivered to the off-site laboratory. Step 44 can also be performed using a private courier service such as Federal Express or United Parcel Service, or by hand delivery. Overnight or faster service may be appropriate if obtaining the test results is urgent.

After the sample is received by the off-site laboratory, step 46 of analyzing the test sample is typically performed using conventional analytical techniques to yield test results. Depending on the particular collection and storage device used, a sample to be tested generally arrives at the laboratory as either a dried liquid (e.g., a dried blood spot), a liquid (e.g., whole blood, serum, or plasma), or solid tissue (e.g., hair clippings or skin scrapings). Such samples can be analyzed by known techniques in clinical chemistry. See, e.g., Tietz Textbook of Clinical Chemistry, C. Burtis, E. Ashwood, and N. Tietz (eds), 3rd edition (July 1998), W B Saunders Co; and Clinical Diagnosis and Management by Laboratory Methods, J. Henry (ed.), 19th edition (April 1996), W B Saunders Co. For example, blood samples (e.g., dried blood spots, undried whole blood, serum, and plasma) can be analyzed by conventional clinical chemistry to determine levels of, e.g., hemoglobin A1c, lipids, total cholesterol, HDL cholesterol, LDL cholesterol, triglycerides, homocysteine, CR protein, ALT, acid phosphatase (e.g., tartrate-resistant acid phosphatase), phosphate, calcium and prostate specific antigen (PSA). Similarly urine samples can be assayed for microalbumin and calcium; and fecal samples can be assayed for occult blood.

For diagnosing an infection, the samples can also be analyzed for microorganisms by, for example, analyzing the sample for the presence of all or part of the microorganism, chemicals associated with infections caused by the microorganisms, or antibodies to the microorganism. See, e.g., Bailey & Scott's Diagnostic Microbiology, B. A. Forbes, D. Sahm, and A. Weissfeld (eds.), 10th edition (March 1998), Mosby-Year Book; and Manual of Clinical Microbiology, P. Murray, E. J. Baron, and M. A. Pfaller (eds.), 7th edition (April 1999), American Society for Microbiology.

For example, samples could be analyzed for infections caused by a bacteria such as staphylococci, streptococci, neisseria, enterobacteria, vibrionacae, pseudomonas, brucella, yersinia, francisella, haemophilus, bortadella, legionella, bacillus, clostridium, corynbacteria, listeria, mycobacteria, treponema, borrelia, leptospira, mycoplasma, rickettsiae, and chlamydiae; fungi such as yeasts and molds; and viruses such as HSV-1, HSV-2, varicella-zoster, cytomegalovirus, EBV, polyomavirus, papillomavirus, adenoviridae, parvovirus, adenoassociated virus, poxviridae, HIV-1, HIV-2, non-HIV retroviridae, HAV, HBV, HCV, togaviridae, bunyaviridae, polioviruses, coxsackieviruses, echoviruses, rhinoviruses, reoviruses, rotaviruses, orbiviruses, coronaviridae, influenza A, influenza B, influenza C, paramyxoviridae, rhabodoviridae, and arenaviridae. Additionally, the samples could be analyzed for other diseasecausing or disease-associated agents such as prions, protozoa, and helminths.

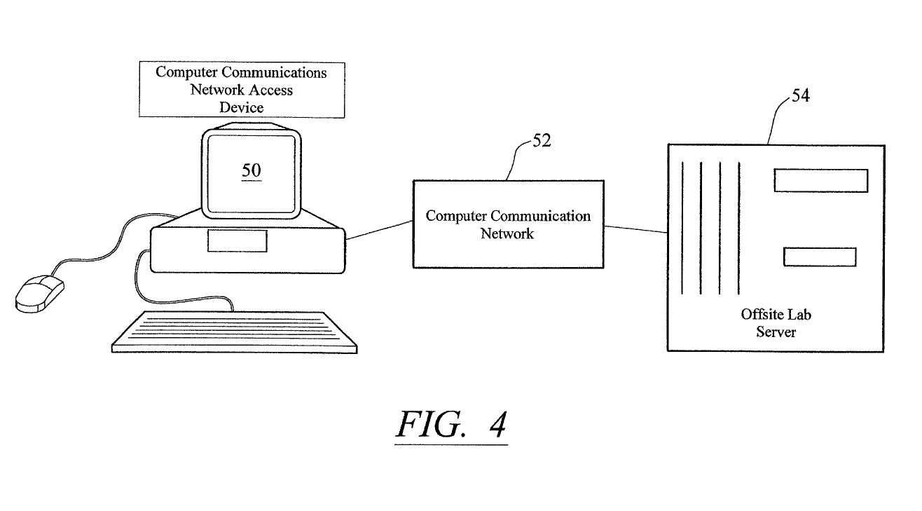

After a sample has been analyzed at the off-site laboratory, in step 48 of the method of the invention, a computer communications network can be used to report the test results. Referring to FIG. 4, a computer communications network includes a computer communications network access device 50 (e.g., a computer connected to the Internet), a computer communications network 52 (e.g., the Internet, a LAN, or a WAN), and an offsite laboratory server 54. In step 48, a computer operator can provide the test results including a reference number, type of test performed, date of test performed, results and comments. Preferably, the results can be provided through a graphical user interface (GUI) to a database wherein each graphical field in the GUI can map to a field in a record in the database. The design and implementation of a GUI to a database is well known in the art and can be performed without specific knowledge of computer programming using such rapid application development tools as Microsoft Visual Basic, Powersoft Powerbuilder or Inprise Delphi.

In the preferred embodiment, the results of a test can be stored in a record in a database. The definition, creation and population of a database also is well known in the art, and can be performed without specific knowledge of database administration using such database tools as Microsoft Access, Powersoft Powerbuilder or Oracle 8i. Still, the use of a database is not required and the invention is not so limited in this regard. Rather, the test results can be stored using any suitable means, for instance merely streaming the results into a text file. However, the flexibility and speed with which a database can be searched provides an incentive for utilizing such technology in the preferred embodiment of the present invention.

In the preferred embodiment, the database can be accessed by a remote user across the Internet using nothing more than a client Web browser. More particularly, a data access Web page can be provided by the Web server to the client in which the client can enter suitable data with which an appropriate database query can be constructed. Preferably, the test results can be retrieved from the database using the database query and can be provided to the user in a dynamically formed results Web page.

Hence, in the preferred embodiment, a Web server having access to the database is provided through which HTTP requests for data can be translated to a query of the database. Notably, the Web server can contain server-side scripts which can be used to provide database queries to external databases. Additionally, the server-side scripts can be used to provide server-side functionality. In the preferred embodiment, the server-side scripts can be implemented in Javascript or Perl. Alternatively, the server-side functionality can be implemented using Microsoft Active Server Pages (ASP).

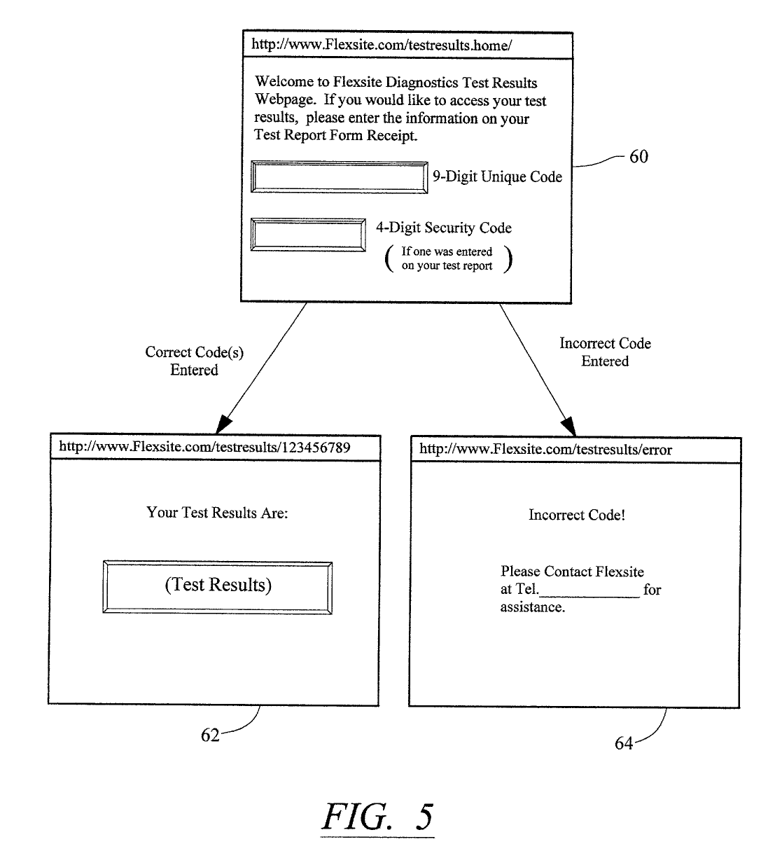

Referring again to FIG. 4, the subject or the subject's health care provider can access the database using a Web browser by directing the browser to the off-site laboratory's Web page. An exemplary data access Web page 60 is shown in FIG. 5. The client Web browser can encapsulate the provided data in an HTTP request and can transmit the request to the Web server 54. Upon receiving the request, the Web server 54 can extract the provided data and can form a database query thereon. Notably, the request can include a user identification and password. The Web server 54 can extract the user identification and password from the request and can query a separate database in order to authenticate the user. If the user's identity cannot be authenticated, the user can be provided with Web page 64 indicating the same.

If the user's identity is authenticated, a database query can be formed based on the data provided by the user in the request Web page 60. The database query can be any suitable query operable to access the database and retrieve a result set of records consonant with the query. Still, in the preferred embodiment, the query is a structured query language (SQL) query which can be used to retrieve result sets from most contemporary databases. The database query can be implemented in a server-side script and transmitted to a database interface. Typically, the manipulation of records in a database can be performed through an interface, for example an Open Database Connectivity (ODBC) interface. The inventions however, is not limited with regard to the method of accessing and manipulating data in the database. Rather, any suitable database interface will suffice.

Upon receiving the database query, preferably containing the identification of the data requestor, the database can provide a result set of records, preferably containing the requested test results. The result set can be returned to the server-side script which can perform additional processing thereon, for instance data formatting. Subsequently, a results Web page 62 can be dynamically formed having therein the result set. Methods of dynamically forming Web pages are well-known in the art and are implemented with ease using, for example, Perl scripting. Once formed, the results Web page 62 can be transmitted to the requesting client as an HTTP reply thereby providing the user with the requested test results.

Alternatively, using a form supplied along the sample collection kit, the subject or his health care provider can designate the address of an electronic post office box to which the test results are to be sent. After obtaining the test results, the off-site laboratory can have the results transmitted over a computer communications network to the designated electronic mailbox address.

### EXAMPLES

### Example 1

The invention can be illustrated by describing an adaptation of a commercially available method and device for measuring hemoglobin A1c in test subjects. Flexsite Diagnostics, Inc. (Palm City, Fla.) commercially markets a kit under the trademark A1c At Home™ for assaying blood levels of hemoglobin A_{1C} (HbA_{1C}), a reliable measurement of how well a diabetic subject is controlling his blood glucose levels over the long tern. The kit includes a lancet for pricking a finger to obtain a blood sample; a paper test request form including a blotter material for receiving a sample; written instructions for using the kit; a plastic bag for enclosing the test request form/blotter material; an envelope pre-addressed to the off-site laboratory for mailing the test request form/blotter material to the off-site laboratory; and a adhesive label that the subject can address if he wishes the results to be sent to his health care provider.

The paper test request form of the kit has attached thereon a first sheet having blank spaces for indicating (e.g., by writing or typing) a test subject's name, age, mailing address, and telephone number; date sample applied; various medical questions; a health care provider's name and signature (if necessary to authorize the test); and a unique code (in barcode format) for identifying the particular kit. Two carbon copy sheets are also attached to the test request form, so that the original and one copy can be sent to the off-site laboratory; and the other copy can be retained by the test subject for his record keeping. Also attached to the test request form is a blotter material having two circles drawn thereon into which the sample is applied. The blotter material is affixed to one of the carbon copy sheets for identification purposes.

As indicated in the written instructions, the test is performed by the subject providing a blood sample (e.g., by pricking a finger with a sterile lancet), applying the blood sample to the indicated place on the blotter material attached to the test request form; allowing the blotter material to dry overnight; sealing the blotter material/test request form in the plastic bag, enclosing the plastic bag in the envelope addressed to an off-site clinical laboratory; and then mailing the envelope. Upon receipt of the blotter material/test request form, the off-site laboratory analyzes the sample and then mails the results of the analysis back to the subject and/or to the subject's health care provider.

### Example 2

In a preferred embodiment of the invention, the kit described in Example 1 is adapted such that the test results obtained can be reported over a computer communications network by adding a description of how to access the test results over the network to the written instructions included with the kit. If anonymity is desired, the test report form included in the kit of Example 1 can be changed to delete one or more of the blank spaces for indicating test subject's name, age, mailing address, and telephone number; the various medical questions; the health care provider's name; or any other identifying information. Of importance, the test request form should retain a unique code for identifying the particular kit. The unique code is preferably preprinted on the test request form in bar code format, but can be entered by the subject if desired. In preferred variations of this example, an electronic address (e.g., URL) for accessing the test results is printed on the test request form or written instructions.

In this example, the test is performed as described in Example 1, except that the test results are not mailed to the subject or his health care provider as a matter of course. Rather, after the test results are obtained at the off-site laboratory, they are entered into a computer database accessible over a computer communications network such as the Internet. For convenience, the computer database is preferably located in a server located at the off-site laboratory itself. The subject can obtain the test results using a computer communications network access device by directing its browser to a Web site where the test results can be accessed. For example, the off-site laboratory can have a homepage hyperlinked to another Web page entitled “test results.” By mouse-clicking on the hyperlink, the subject accesses the “test results” Web page which queries him for a unique code that identifies the particular test kit. The subject enters the code (subject retained a copy of the code from a portion of the kit) on the Web page and transmits the entered code to the off-site laboratory via the computer communication network. The off-site laboratory's server then receives and processes this transmission. If the entered code is appropriate (e.g., matches a code stored in the off-site laboratory's database), then the off-site laboratory's server sends a Web page having the test results to the subject's computer communications network access device. Additionally or alternatively, the tests results can be sent to the subject's or his health care provider's predesignated electronic mailbox.

### Example 3

As an example of another preferred embodiment of the invention, the kits described in Examples 1 and 2 are modified by adding a blank space to the test request form on which the subject can indicate his and/or his health care provider's e-mail address. After the off-site laboratory obtains the test results, it sends them electronically over a computer communications network to the indicated e-mail address(es). For example, after the test results become available, a technician enters the results into a computer database or an electronic message. Then, utilizing a computer communications network to which the off-site laboratory's computer is connected, the technician addresses and sends the test results to the subject's or his subject's health provider's electronic mail box. The subject or his health care provider can then access the electronic mail box to obtain the test results.

### Example 4

To ensure privacy and prevent errors, the kits described in the foregoing examples are preferably marked with a unique 9 digit alphanumeric code. Prior to mailing the test report form/blotter material to the offsite laboratory, the subject or the subject's health care provider records the code (or retains a component of the kit having the code thereon) and also writes an additional alphanumeric code (e.g., the last four digits of a subject's telephone number or social security number) on the test report form. After the test results are obtained and made available by the off-site laboratory, the subject or the subject's health care provider accesses the laboratory's Web page which prompts the subject or the subject's health care provider to enter both (a) the unique 9 digit alphanumeric code used to identify the kit and (b) the additional alphanumeric code. Only after entry of both correct codes will the subject or the subject's health care provider be allowed access to the test results.

Referring again to FIG. 5, a “Test Results” Web page 62 that can be accessed by the subject or his health care practitioner is shown. As shown, Web page 60 queries the subject for both the unique 9 digit alphanumeric code used to identify the kit and the additional alphanumeric code. The subject then enters the requested information at the appropriate data entry positions on the “Test Results” Web site. The entered code is then transmitted to the laboratory's server, which determines whether or not the entered codes matches the codes corresponding to a particular test result. If so, the server responds by sending the test result to the subject/Health Care Practitioner over another Web page. If not, an error page is sent (e.g., “incorrect code, please try again”).

### Other Embodiments

While the above specification contains many specifics, these should not be construed as limitations on the scope of the invention, but rather as examples of preferred embodiments thereof. Many other vaiations are possible. For example, the invention is not limited to diagnosing animal conditions, as it could also be used to detect various analytes or contaminants in non-living items such as food products, the atmosphere, etc. Accordingly, the scope of the invention should be determined not by the embodiments illustrated, but by the appended claims and their legal equivalents.

What is claimed is:

1. A method for performing an analytical assay on a test sample, the method comprising the steps of:
(A) providing a kit for collecting and storing a test sample, the kit comprising a sample collection device, a sample storage device, and a printed material having indicated thereon an electronic address for accessing a test result obtained from analysis of the test sample;
(B) collecting the test sample from a subject at a first location using the sample collection device;
(C) placing the collected sample into the sample storage device;
(D) transporting the sample storage device containing the collected test sample to an off-site laboratory;
(E) analyzing the collected test sample for at least one analyte at the off-site laboratory to generate the test result; and
(F) posting the test result over a computer communications network.

2. The method of claim 1, wherein the first location is selected from the group consisting of: a private residence; a health care provider's office; and a hospital.

3. The method of claim 1, wherein the step of transporting the sample storage device containing the collected test sample to an off-site laboratory comprises mailing the sample storage device to the off-site laboratory.

4. The method of claim 1, wherein the at least one analyte comprises a substance selected from the group consisting of: blood, hemoglobin, lipids, total cholesterol, HDL cholesterol, LDL cholesterol, triglycerides, homocysteine, CR protein, ALT, calcium, phosphate, acid phosphatase, prostate specific antigen, and microalbumin.

5. The method of claim 4, wherein the at least one analyte comprises a glycolsylated hemoglobin.

6. The method of claim 5, wherein the glycolsylated hemoglobin is hemoglobin A1c.

7. The method of claim 1, wherein the at least one analyte comprises a microorganism.

8. The method of claim 7, wherein the microorganism is a bacterium selected from the group consisting of: staphylococci, streptococci, neisseria, enterobacteria, vibrionacae, pseudomonas, brucella, yersinia, francisella, haemophilus, bortadella, legionella, bacillus, clostridium, corynbacteria, listeria, mycobacteria, treponema, borrelia, leptospira, mycoplasma, rickettsiae, and chlamydiae.

9. The method of claim 7, wherein the microorganism is a fungus.

10. The method of claim 7, wherein the microorganism is a virus selected from the group consisting of HSV-1, HSV-2, varicella-zoster, cytomegalovirus, EBV, polyomavirus, papillomavirus, adenoviridae, parvovirus, adeno-associated virus, poxviridae, HIV-1, HIV-2, non-HIV retroviridae, HAV, HBV, HCV, togaviridae, bunyaviridae, polioviruses, coxsackieviruses, echoviruses, rhinoviruses, reoviruses, rotaviruses, orbiviruses, coraonaviridae, influenza A, influenza B, influenza C, paramyxoviridae, rhabodoviridae, and arenaviridae.

11. The method of claim 1, wherein the at least one analyte comprises a prion.

12. The method of claim 1, wherein the at least one analyte comprises a protozoum.

13. The method of claim 1, wherein the at least one analyte comprises a helminth.

14. The method of claim 1, wherein the computer communications network is a global communications network.

15. The method of claim 14, wherein the global communications network is the Internet.

16. The method of claim 1, wherein the computer communications network is a local area network.

17. The method of claim 1, wherein the computer communications network is a wide area network.

18. The method of claim 1, wherein at least one of the sample collection device, the sample storage device, and the printed material is marked with a unique code for identifying the kit.

19. The method of claim 18, wherein the sample storage device is marked with the unique code.

20. The method of claim 18, wherein the unique code for identifying the kit comprises a sequence of at least 3 alphanumeric characters.

21. The method of claim 18, wherein the unique code for identifying the kit comprises a barcode.

22. The method of claim 18, further comprising a step of providing a Web page that is adapted to allow a person to enter the unique code onto the Web page and transmit an electronic message containing the unique code from a first computer communication network access device remotely-located from the off-site laboratory over the computer communications network to a second computer communication network access device located at the off-site laboratory.

23. The method of claim 22, wherein a computer located at the off-site laboratory receives the electronic message containing the unique code and responds by transmitting an electronic message containing the test results over the computer communications network to the first computer communication network access device.

24. The method of claim 18, wherein the sample collection device comprises a blotter material adapted to receive a blood sample.

25. The method of claim 18, wherein the sample collection device comprises a separation member and a collection member,
the separation member comprising a filter that receives a blood sample and selectively retains cellular components contained within the blood sample while allowing non-cellular components to pass through; and
the collection member comprising a blotter material that receives the non-cellular components of the blood sample after said non-cellular components have passed through the separation member.

26. The method of claim 18, wherein the sample collection device comprises a relatively rigid strip forming a handle member having a handle end and a collection end, the collection end having a collection pad for collecting and drying a urine sample.

27. The method of claim 18, the kit further comprises packaging for mailing the sample storage device.

28. The method of claim 27, wherein the packaging for mailing is marked with a mailing address of the off-site laboratory.

29. A method for performing an analytical assay on a test sample, the method comprising the steps of:
(A) collecting the test sample from a subject at a first location;
(B) transporting the collected test sample to an off-site laboratory;
(C) analyzing the collected test sample for at least one analyte at the off-site laboratory to generate test results; and
(D) electronically transmitting the test results over a computer communications network to an electronic post office box.

30. The method of claim 29, wherein the electronic post office box is selected from the subject's electronic post office box and the subject's health care provider's mailbox.

31. A kit for performing an analytical assay on a test sample comprising:
a printed material having indicated thereon an electronic address for accessing a test result obtained using the kit,
written instructions for using the kit;
a printed material having indicated thereon an alphanumeric code for uniquely identifying the kit;
a means for isolating a sample;
a sample storage device for storing the sample;
a container adapted to contain the sample storage device in a manner such that the sample storage device can be transported to an offsite laboratory.

32. The kit of claim 31, wherein the sample is a biological sample and the kit further comprises a sample collection device selected from the group consisting of a lancet, a needle, a syringe, a razor, and a scissors.

33. The kit of claim 31, wherein the written instructions for using the kit and the printed material having indicated thereon an electronic address for accessing a test result obtained using the kit are on a single sheet of paper.

34. The kit of claim 31, further comprising an envelope having indicated thereon a mailing address of the offsite laboratory.

35. The kit of claim 31, wherein the printed material having indicated thereon the alphanumeric code for uniquely identifying the kit is a test request form adapted such that a test subject is prompted to enter information thereon, said information including at least one selected from the group consisting of: the test subject's name, the test subject's mailing address, the test subject's electronic mail address, the test subject's age, the test subject's sex, the test subject's telephone number, a date the sample was applied to the sample storage device, the test subject's medical condition, the test subject's medical history, and the test subject's medical care provider.

36. The kit of claim 31, wherein the sample storage device is selected from the group consisting of a blotter material, a test tube for storing a liquid, a plastic container, and an envelope.

37. The kit of claim 3 1, wherein the test sample is blood and the biological assay is an assay for an analyte selected from the group consisting of: hemoglobin A1c, lipids, total cholesterol, HDL cholesterol, LDL cholesterol, triglycerides, homocysteine, CR protein, ALT, calcium, phosphate, acid phosphatase, and prostate specific antigen.

38. The kit of claim 31, wherein the test sample is urine and the biological assay is an assay for an analyte selected from the group consisting of: microalbumin and calcium.

39. The kit of claim 31, wherein the biological assay is an assay for a microorganism.

40. The kit of claim 39, wherein the microorganism is a bacterium selected from the group consisting of: staphylococci, streptococci, neisseria, enterobacteria, vibrionacae, pseudomonas, brucella, yersinia, francisella, , haemophilus, bortadella, legionella, bacillus, clostridium, corynbacteria, listeria, mycobacteria, treponema, borrelia, leptospira, mycoplasma, rickettsiae, and chlamydiae.

41. The kit of claim 39, wherein the microorganism is a fungus.

42. The kit of claim 39, wherein the microorganism is a virus selected from the group consisting of HSV-1, HSV-2, varicella-zoster, cytomegalovirus, EBV, polyomavirus, papillomavirus, adenoviridae, parvovirus, adeno-associated virus, poxviridae, HIV-1, HIV-2, non-HIV retroviridae, HAV, HBV, HCV, togaviridae, bunyaviridae, polioviruses, coxsackieviruses, echoviruses, rhinoviruses, reoviruses, rotaviruses, orbiviruses, coraonaviridae, influenza A, influenza B, influenza C, paramyxoviridae, rhabodoviridae, and arenaviridae.

43. The kit of claim 31, wherein the biological assay is an assay for a prion.

44. The kit of claim 31, wherein the biological assay is an assay for a protozoum.

45. The kit of claim 31, wherein the biological assay is an assay for a helminth.
